(19) United States
(12) Patent Application Publication
(10) Pub. No.: US 2004/0028045 A1
(43) Pub. Date: Feb. 12, 2004

(54) Data transmission method for portable communication apparatus

(76) Inventor: Jonathan Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/215,010

(22) Filed: Aug. 9, 2002

(51) Int. Cl. H04L 12/28; H04Q 7/00

(52) U.S. Cl. 370/392; 370/328

(57) ABSTRACT

The invention discloses a data transmission method for the portable communication apparatus, comprising plurality of data transmission steps and each data transmission step is used for implementation a graphic, image, video, or audio process, wherein each step can be at least used for transmitting the 1^{st} header for setting a graphic, image, video, or audio command, the 2^{nd} header for designating the graphic, image, video, or audio parameter information following the graphic, image, video, or audio command and the combination of the said graphic, image, video, or audio command information, and transmitting the graphic, image, video, or audio parameter of the graphic, image, video, or audio command. In particular, if the graphic, image, video, or audio command in this data transmission step is already transmitted in the preceding data transmission step, then, the step for transmitting the 1^{st} header can be omitted. If one of the graphic, image, video, or audio parameters of the graphic, image, video, or audio command in this data transmission step is transmitted in the preceding data transmission step, then, the step for transmitting the graphic, image, video, or audio parameter can be omitted. Moreover, after transmitting the 1^{st}, and 2^{nd} headers and the graphic, image, video, or audio parameter of the said graphic, image, video, or audio command, a graphic, image, video, or audio engine of the said portable communication apparatus will be started for carrying out the required graphic, image, video, or audio process of the graphic, image, video, or audio command.

### FIELD OF THE INVENTION

The invention relates to a data transmission method that can be used in a portable communication apparatus, and more particular relates to a method, which can decrease the transmission and storage volumes of the graphic, image, video, or audio data in a portable communication apparatus.

### BACKGROUND OF THE INVENTION

Portable communication apparatus is designed for providing the users with an data access which can transmit the data to the remote host by means of the wireless transmission, or serving as a media to connecting a server with computer network. Generally speaking, the existing portable communication apparatuses, for example, cellar phone, PDA or wireless LAN equipment, are becoming more popular with the enhancement of their functions. Thus, it's expected that the portable communication apparatus will have a great impact on the communication market before long.

As illustrated in FIG. 1, an example of the system platform structure of the general portable communication apparatus can be applied to a cellar phone or PDA. The system platform of the said portable communication apparatus consists of baseband chipsets 10, comprising a core processor 101 and a peripheral interface 102. Core processor 101 can be a traditional programmable processor, for example, RISC (Reduced Instruction Set Computer) processor, CISC (Complex Instruction Set Computing) processor, or ARM processor, or special-functioned processors, for example, Digital Signal Processor (DSP) or Application-Specific Integrated Circuit (ASIC). Main memory 11 is connected to the said core processor 101, which consists of a Flash PROM, SRAM, or DRAM, and can be used to store control programs, data, and image. Core process 101 is connected to a display controller 13 by the bus structure 12. Bus structure 12 can include, e.g., data bus, address bus, and control bus. The address signal, data signal, and control signal can be transmitted to the display controller 13 based on the clock cycle of the Protocol of the said bus structure 12. Display controller 13 consists of a display memory 13 1, which can be used as a work storage area for temporarily store image and data. The output of the display controller 13 is forwarded to a display device 15, e.g. STN-LCD, TFT-LCD, or Organic EL display, by a multiplex input/output channel 14, to provide the interfaces for users receiving and displaying panel data simultaneously.

However, as the volume of the graphic, image, video, or audio data transmitting between core processor 101 and display controller 13 is very large, the storage space of the display memory 131 shall be increased correspondingly to meet the demand. In addition, when bus structure 12 is used for transmitting great volume of graphic, image, video, or audio data, representative of the power consumption will increased accordingly, and the time for data output will be extended and, thus, reduce the data transmission efficiency. Furthermore, the storage capacity of the main memory 11 shall also be increased so as to have a larger volume of control programs and image data.

It is necessary to provide a data transmission method for transmitting data on the portable communication apparatus are well known, and recent advances in storage space of the display memory miniaturization have seen a remarked reduction in size and cost of such apparatus together with an improvement performance, and for saving the power consumption by minimizing the transmitting amount of graphic, image, video, or audio parameters occur in each transmission step. Furthermore, address bus can be used to transmitting graphic, image, video, or audio data, so that shortening the time for data transmission can enhance the data transmission efficiency.

### SUMMARY OF THE INVENTION

Accordingly, it is an object of this invention to solve described above problem, to provide a data transmission method for the portable communication apparatuses, such as cellar phone, PDA or Wireless LAN equipment. The transmission data method for the portable communication apparatus comprises plurality of data transmission steps and each data transmission step is used for implementation a graphic, image, video, or audio process; wherein each step can be at least used for transmitting the 1^{st} header for setting a graphic, image, video, or audio command, the 2^{nd} header for designating the graphic, image, video, or audio parameter information following the graphic, image, video, or audio command and the combination of the said graphic, image, video, or audio command information, and the graphic, image, video, or audio parameter of the graphic, image, video, or audio command. Especially, if the graphic, image, video, or audio command in this data transmission step has already been transmitted in the preceding data transmission step, then, the step for transmitting the 1^{st} header can be omitted. If one of the graphic, image, video, or audio parameters of the graphic, image, video, or audio command in this data transmission step has already been transmitted by the preceding data transmission step, then, the step for transmitting the graphic, image, video, or audio parameter can be omitted. Moreover, after transmitting the 1^{st} and 2^{nd} headers and the graphic, image, video, or audio parameter of the said graphic, image, video, or audio command, a graphic, image, video, or audio engine of the said portable communication apparatus will be started for completing the required drawing of the graphic, image, video, or audio command. Especially, the transmission sequence of the steps for transmitting the said 1^{st} and 2^{nd} headers, and the said graphic, image, video, or audio parameter of the graphic, image, video, or audio command can be adjusted optionally.

More specific, the 2^{nd} header can indicate further the transmission sequence of the graphic, image, video, or audio parameter of the graphic, image, video, or audio command, or even the 2^{nd} header further designates to show how to merge transmitted information related to the graphic, image, video, or audio parameter of the graphic, image, video, or audio command.

On the other hand, it is an object of this invention to provide a floating header of the data transmission method for the portable communication apparatus, wherein the data transmission method includes plurality of transmission steps, and each data transmission step used for completing a graphic, image, video, or audio process, wherein the floating header at least includes: a 1^{st} field for designating an attribute of a subsidiary graphic, image, video, or audio parameter following after a floating header; and a 2^{nd} field for designating a graphic, image, video, or audio command of a required graphic, image, video, or audio process.

The 1^{st} field prefers to be a data structure of 2 bytes, the 2^{nd} field, 4 bytes. Furthermore, the floating header can selectively include a 3^{rd} field, a one byte data structure with a binary value for setting the said 2^{nd} field so as to designate the command for completing the desired graphic, image, video, or audio process. More especially, an address bus, data bus or address/data bus of a parallel bus structure, or an address/data bus of a serial bus structure transmits the said 1^{st}, 2^{nd}, and 3^{rd} fields.

It is still another object of this invention is to provide a floating header in the data transmission method for the portable communication apparatus. The data transmission method includes plurality of data transmission steps, wherein each data transmission step is used for completing a graphic, image, video, or audio process, wherein the floating header at least includes a 1^{st} field for designating the attribute of a graphic, image, video, or audio parameter subordinated to the floating header, and a 2^{nd} field for designating the graphic, image, video, or audio parameter information following the graphic, image, video, or audio command and a combination of the said graphic, image, video, or audio command information.

Specially, the 2^{nd} field can further designate the transmission sequence of the graphic, image, video, or audio parameters of the graphic, image, video, or audio command, or even the 2^{nd} header further designates to show how to merge transmitted information related to the graphic, image, video, or audio parameter of the graphic, image, video, or audio command. It had better that the 1^{st} field is a data structure of 2 bytes, and the 2^{nd} field, 4 bytes. Furthermore, the floating header can selectively include a 3^{rd} field, a one byte data structure with a binary value for setting the 2^{nd} field so as to designate the graphic, image, video, or audio parameter information of a graphic, image, video, or audio command and a combination of the said graphic, image, video, or audio command information. What makes it even more special is that an address bus, data bus or address/data bus of a parallel bus structure, or an address/data bus of a serial bus structure transmits the said 1^{st}, 2^{nd}, and 3^{rd} field.

Further aspects and advantages of the present invention will become apparent from the following description given in conjunction with the appended drawings.

### BRIEF DESCRIPTION OF THE DRAWINGS

FIG. 1 is a schematic diagram illustrated the conventional portable communication system platform;

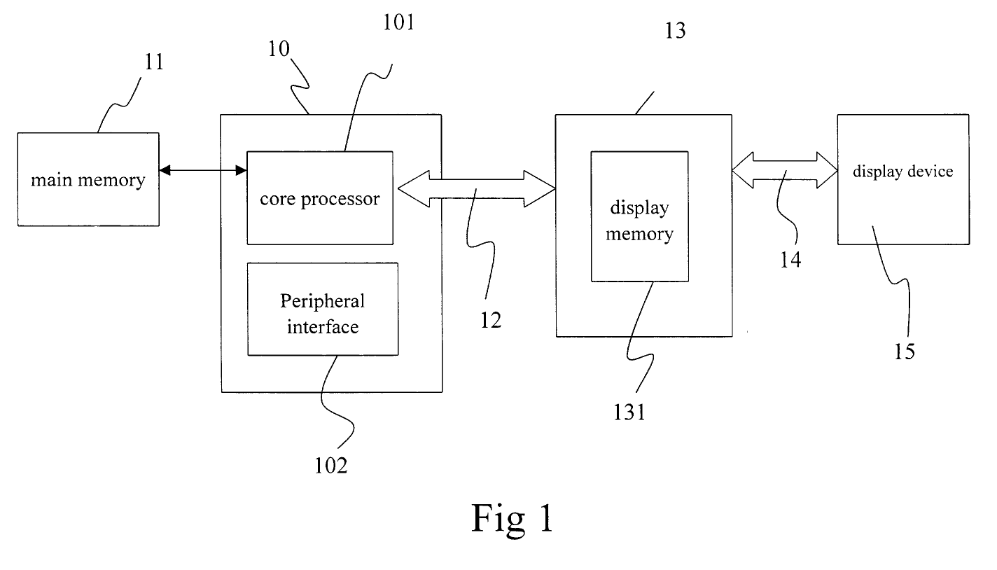

FIG. 2 is a schematic diagram illustrated the portable communication system platform of this invention;

FIG. 3 is a schematic diagram illustrated a bus structure in the portable communication apparatus of this invention;

FIG. 4 shows a list of the floating header in this invention;

FIG. 5 shows a field description table of the floating header in this invention.

FIG. 6 is a list illustrated the possible graphic, image, video, or audio command and the required graphic, image, video, or audio parameter of the floating headers command/parameter information indicator fields in this invention;

FIG. 7 is a list illustrated the possible forms of the graphic, image, video, or audio parameters in this invention;

FIG. 8 is a list illustrated the floating headers command/parameter information indicator fields in this invention, for designating the graphic, image, video, or audio parameter information and a combination of the graphic, image, video, or audio command information; and

FIG. 9 is a chart illustrated the preferred embodiment of the present invention.

### DETAILED DESCRIPTION OF THE PREFERRED EMBODIMENT

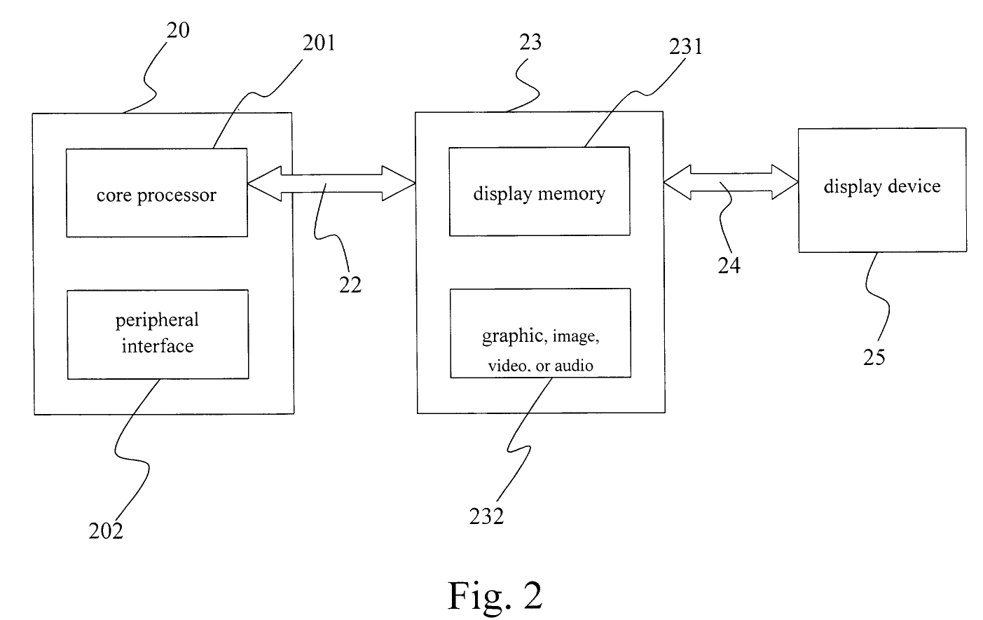

Please refer to FIG. 2, is a schematic view showing the portable communication system platform of this invention. The portable communication platform could be applied to a cellar phone, PDA or Wireless LAN equipment. As illustrated in FIG. 2, the system platform of the portable communication apparatus in this invention consists of baseband chipsets 20,comprising a core processor 201 and a peripheral interface 202. Core processor 201 can be a traditional programmable processor, for example, RISC (Reduced Instruction Set Computer) processor, CISC (Complex Instruction Set Computing) processor, or ARM processor, or special-functioned processors, for example, DSP or ASIC. Core process 201 and peripheral interface 202 is connected to a display controller 23 through the bus structure 22. Bus structure 22 can include, e.g., data bus, address bus, control bus and the like. The address signal, data signal, and control signal can be transmitted to the display 23 within the processor based on the clock cycle of the Protocol of the said bus structure 22. Display controller 23 consists of a display memory 231, which can be used as a work storage area for temporarily store image and data. Especially, display controller 23 includes a built-in graphic, image, video, or audio engine 232 which can provide the built-in command set for supporting the core processor 201 regulated in the Protocol, and which also includes hardware graphic, image, video, or audio functions such as starting up the windows, so as to simplify the window control. The output of the display controller 23 is forwarded to a display device 25 for example, STN-LCD, TFT-LCD, or Organic EL display by a multiplex input/output access 24, so as to provide a user's interface for receiving and displaying image data simultaneously.

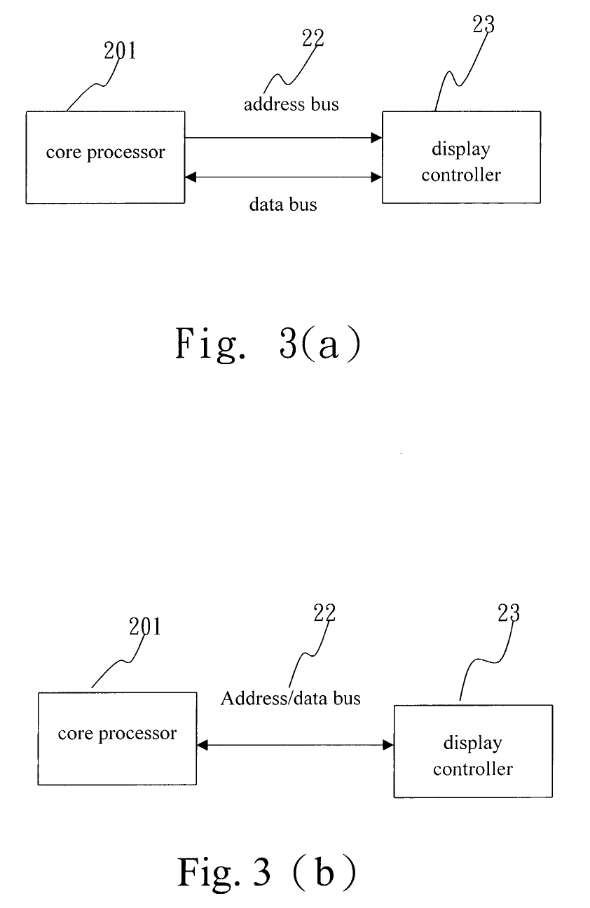

FIG. 3(a) is a system schematic illustrated the bus structure 22 of the connecting core (host) processor 201 and display controller 23 in the portable communication platform of this invention. The bus structure shown in FIG. 3(a) is a kind of parallel bus structure (8 or 16 bytes), wherein the address signal forwarded by address bus parallels with the transmission of the data delivered by the data bus. FIG. 3(b) is the other system schematic illustrated the bus structure 22 of the connecting core (host) processor 201 and display controller 23 in the portable communication apparatus system platform of this invention. The bus structure shown in FIG. 3(a) is a kind of parallel bus structure or a sort of serial bus structure, wherein the address/data bus transmits the address signal and data signal in sequence within the regulated bus clock cycle in accordance with the communication protocol of bus structure 22.

In an attempt to decrease the data transmission volume between core processor 201 and display controller 23, and display the volume of the storage-required data 231, this invention provides a data transmission method for the portable communication apparatuses such as cellar phones, PDAs, Wireless LAN equipments and the like. Meanwhile, the data transmission method of this invention is applicable to the data transmission conducted between core processor 201 and display controller 23 through bus structure 22. The said method can operate in line with bus cycle of the parallel bus structure shown in FIG. 3(a), and the serial bus structure shown in FIG. 3(b)

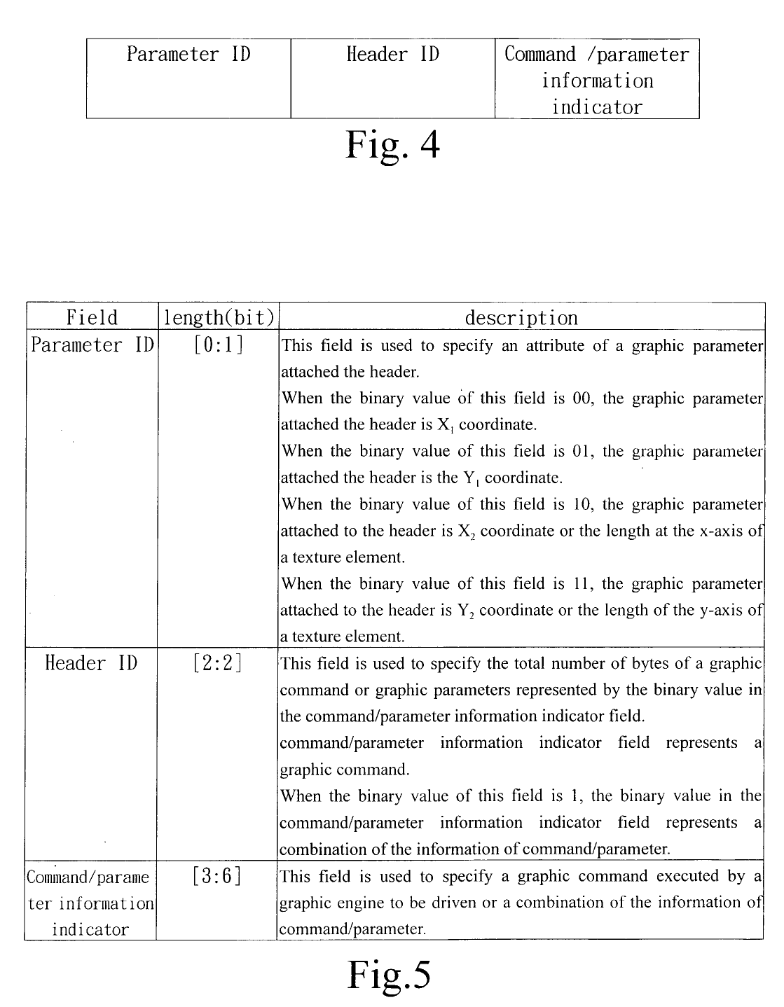

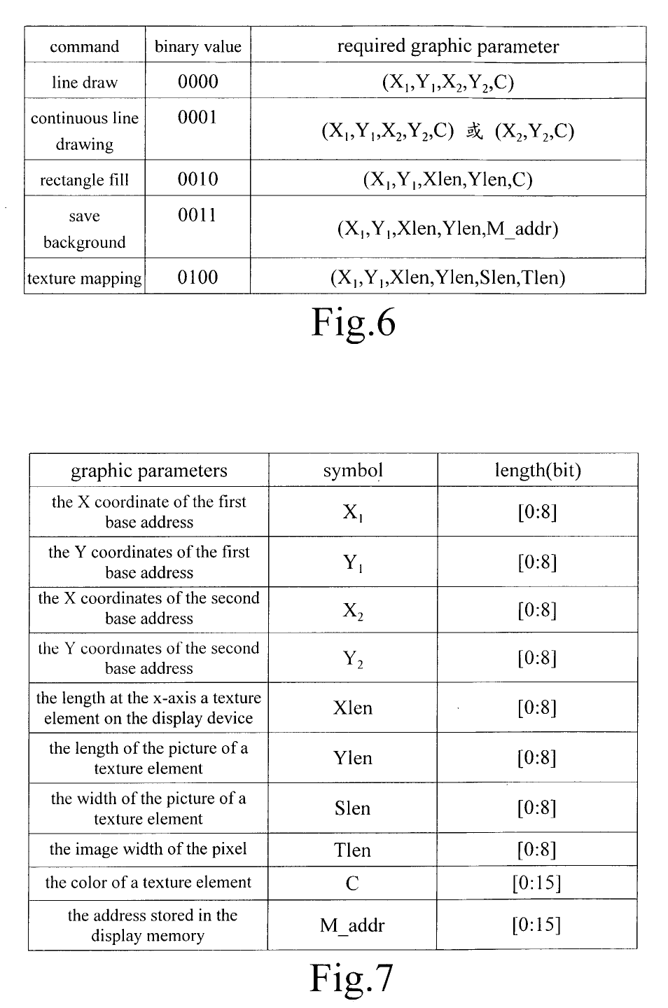

Basically, the data transmission method of this invention makes use of a floating header, which can combine with the transmission-required data, and attach the transmission-required data to the header, so as to conduct the transmission by an address/data bus of a sequential bus, or an address bus, data bus or address/data bus of a parallel bus structure along with the header. Principally, the floating header of this invention functions as the hardware possessed by the starting graphic, image, video, or audio engine 232. The said floating header can also define the total amount of the parameter bytes required for graphic, image, video, or audio command. A preferred embodiment of this invention constructs that the floating header at least having two kinds of type, and three fields. The list and description of the fields of the floating headers will be explained with FIG. 4 and FIG. 5 in the followings.

FIG. 4 shows the list of the floating header in this invention. The floating header of this invention consists of a parameter ID field, a header ID field and a command/parameter information display field. As illustrated in FIG. 5, the floating header of this invention is a data structure of 7 bytes length. The parameter ID field is a 2 bytes length field conversed from the MSB which can be used for designating the attribute of the graphic, image, video, or audio parameter subordinated to the header. While the binary value of the parameter ID field is 00, (X₁) representative of the graphic, image, video, or audio parameter subordinated to the header is the X coordinate shown on the 1^{st} standard address of the display device. While the binary value of the parameter ID field is 01, (Y₁) representative of the graphic, image, video, or audio parameter subordinated to the header is the Y coordinate shown on the 1^{st} standard address of the display device. While the binary value of the parameter ID field is 10, (X₂) representative of the graphic, image, video, or audio parameter subordinated to the header is the X coordinate shown on a 2^{nd} standard address of the display device, or (Xlen) representative of the length of the pixel on the X axis. While the binary value of the parameter ID field is 11, (Y₂) representative of the graphic, image, video, or audio parameter subordinated to the header is the Y coordinate shown on a 2^{nd} standard address of the display device, or (Ylen) indicates the length of the pixel on the Y axis. As for header ID, it is a field of one byte length that can be used for representative whether the binary value of the follow-up command/parameter information indicator represents the graphic, image, video, or audio command, or the graphic, image, video, or audio parameter information of the graphic, image, video, or audio command, and the combination of graphic, image, video, or audio command information. While the binary value of the header ID field is 0, representative of the binary value of the command/parameter information indicator field is a graphic, image, video, or audio command. While the binary value of the header ID field is 1, representative of the binary value of the command/parameter information indicator field is the graphic, image, video, or audio parameter information following the graphic, image, video, or audio command and a combination of the said graphic, image, video, or audio command information, the transmission sequence of graphic, image, video, or audio parameter, and to show how to merge the transmitted information related to the graphic, image, video, or audio parameter of the graphic, image, video, or audio command.

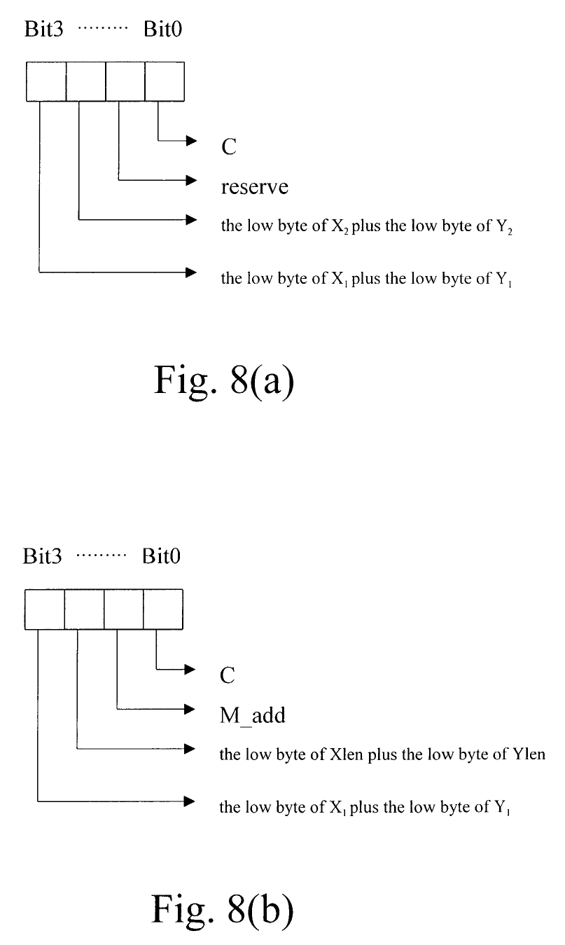

Command/parameter information indicator field is a field of 4 byte length, which is used to designate the graphic, image, video, or audio command in driving the graphic, image, video, or audio engine, or the graphic, image, video, or audio parameter information of graphic, image, video, or audio command and the combination of graphic, image, video, or audio command information, the transmission sequence of graphic, image, video, or audio parameter, and to show how to merge the transmitted information related to the graphic, image, video, or audio parameter of the graphic, image, video, or audio command. Nevertheless, whether it is used for indicating the graphic, image, video, or audio command, or the graphic, image, video, or audio parameter information following up the graphic, image, video, or audio command and a combination of graphic, image, video, or audio command information will be determined by the binary value of the header ID field. FIG. 6 is a list illustrated the possible graphic, image, video, or audio command and the required graphic, image, video, or audio parameter of the floating headers command/parameter information indicator fields in this invention. While the binary value of the header ID field is 1, and the binary value of the command/parameter information indicator field is 0000, representative of the graphic, image, video, or audio command released by the core processor 201 is for line drawing, and the required parameters (X₁, Y₁) are the X and Y coordinates of the 1^{st} standard address, and (X₂, Y₂) are X and Y coordinates of the 2nd standard address, and the color of the line. While the binary value of the header ID field is 1, and the binary value of the command/parameter information indicator field is 0001, representative of the graphic, image, video, or audio command released by the core processor 201 is for continuous line drawing, and the required parameters (X₁, Y₁) are the X and Y coordinates of the 1^{st} standard address, (X₂, Y₂) indicates X and Y coordinates of the 2nd standard address, and the color of the line (C), or (X₂, Y₂) merely the X and Y coordinates of the 2nd standard address and the color of the line (C) are required to start drawing the continuous line from the 2^{nd} standard address. While the binary value of the header ID field is 1, and the binary value of the command/parameter information indicator field is 0010, representative of the graphic, image, video, or audio command released by the core processor 201 is for rectangle filling, and the required parameters (X₁, Y₁) are the X and Y coordinates of a rectangle, (Xlen, Ylen) indicates the length and width of a rectangle, and the demanded color for filling the said rectangle so that the designated rectangle area will be filled with one color. While the binary value of the header ID field is 1, and the binary value of the command/parameter information indicator field is 0011, representative of the graphic, image, video, or audio command released by the core processor 201 is for background storage, and (X₁, Y₁) indicates the required parameters are the X and Y coordinates of a rectangle window's standard address, (Xlen, Ylen) indicates the length and width of a rectangle window, and the desired memory address (M_addr) to store display memory 231, so as to save a rectangle window background at a designated address on the display memory 231. While the binary value of the header ID field is 1, and the binary value of the command/parameter information indicator field is 0100, representative of the graphic, image, video, or audio command released by the core processor 201 is texture mapping, and (X₁, Y₁) indicates the required parameters are the X and Y coordinates of a standard address, (Xlen, Ylen) indicates the length and width of the pixel on the display device 25, and (Slen, Tlen) indicates the length and width of the pixel image, so as to map the pixel on the designated address on the said display device 25. And the arithmetic operating codes of the other graphic, image, video, or audio functions will be kept temporally as further supplement.

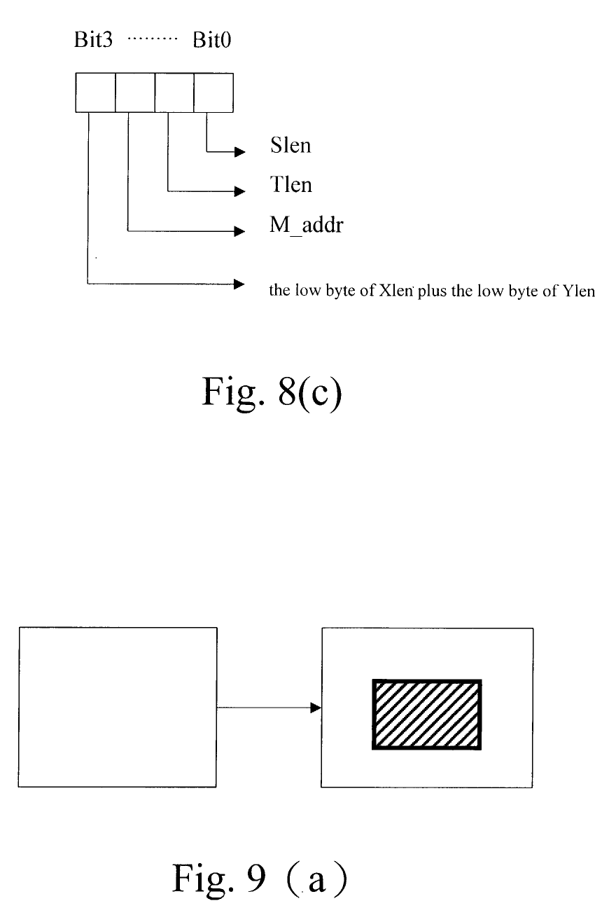

Please refer to FIG. 7, shows all kinds of lists related to the required graphic, image, video, or audio parameters of the graphic, image, video, or audio command, wherein (X₁, Y₁) indicates the X and Y coordinates at a standard address on the display device, (Xlen, Ylen) indicates the length and width of the pixel on the display device, and (Slen, Tlen) indicates the length and width of the pixel image will all be represented by a binary value of 9 byte, and the address of the graphic, image, video, or audio data saved on the display memory will be a binary value address signal of 16 byte. Furthermore, the graphic, image, video, or audio parameters, which represent the color of the pixel, will be a data structure of 16 byte. Some of the pixels represent red (R), some represents green (G), and some represents blue (B).

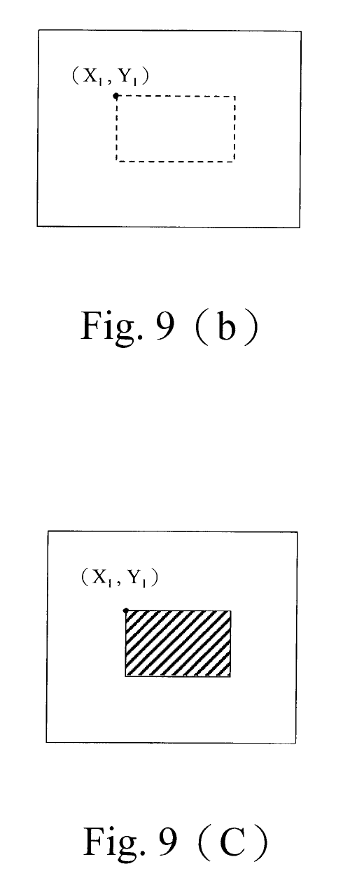

FIG. 8 shows the list of the floating headers command/parameter information indicator fields in this invention used for designating the graphic, image, video, or audio parameter information of the graphic, image, video, or audio command and a combination of the said graphic, image, video, or audio command information. FIG. 8(a) shows that graphic, image, video, or audio command is the layout of the data of the line-drawing graphic, image, video, or audio parameters, wherein the binary value of bit0 represents the color (C) of the line, bit1 will be reserved for future use, the binary value of Bit2, (X₂lowbyte+Y₂lowbyte), represents the low bytes X and Y coordinates of the 2^{nd} standard address, and the binary value of Bit3, (X₁lowbyte+Y₁lowbyte), represents the low bytes X and Y coordinates of the 1^{st} standard address. FIG. 8(b) shows that the graphic, image, video, or audio command proceeding rectangle operation, for example, the list of the graphic, image, video, or audio parameter information of background storage, and rectangle filling, wherein the binary value of bit0 represents the color (C) for filling the rectangle, the binary value of bit1 represents the memory address (M_addr) to store on the display memory 231. The binary value of bit2, (Xlenlowbyte+Ylenlowbyte), represents the low bytes of the length and width of the rectangle, while the binary value of bit3, (X₁lowbyte+Y₁lowbyte), represents the low bytes X and Y coordinates of the 1^{st} standard address. FIG. 8(b) indicates that the graphic, image, video, or audio command is the data list of the texture mapping graphic, image, video, or audio parameters, wherein the binary value of bit0, (Slen), represents the image length of the pixels, and the binary value of bit1, (Tlen), represents the image width of the pixel, the binary, image, video, or audio value of bit2 represents the memory address (M_addr) to store on the display memory 231, and the binary value of bit3, (Xlenlowbyte+Ylenlowbyte), represents the length and width of the pixels on the display device 25.

Next, the present invention substantially overcomes the foregoing limitations of the prior art by providing a data transmission means employing the data transmission method for the portable communication apparatus, wherein the data transmission method may comprise following characteristic. in the beginning to transmit the 1^{st} header (H₀) for setting the graphic, image, video, or audio command and the 1^{st} graphic, image, video, or audio parameter; then, transmit the 2^{nd} header (H₁) for designating the graphic, image, video, or audio parameter information following the graphic, image, video, or audio command and a combination of the information of the said graphic, image, video, or audio command, and a 2^{nd} graphic, image, video, or audio parameter; and transmit the remaining graphic, image, video, or audio parameter. And if due to the said graphic, image, video, or audio command and parameter have been recited, therefore there is no necessary to retransmission the said graphic, image, video, or audio command and parameter. Furthermore, after receiving the 2^{nd} graphic, image, video, or audio header, the subsidiary 2^{nd} graphic, image, video, or audio header, all the other graphic, image, video, or audio parameters, and the display controller 23 will start up the built-in graphic, image, video, or audio engine automatically so as to accomplish the graphic, image, video, or audio process by graphic, image, video, or audio command. In this preferred embodiment, the sequence for data transmission is described as the following: first to transmit the 1^{st} header and the 1^{st} graphic, image, video, or audio parameter, then to transmit the 2^{nd} header and the 2^{nd} graphic, image, video, or audio parameter, and transmit the other graphic, image, video, or audio parameters in order. Nevertheless, the transmission sequence for forwarding the graphic, image, video, or audio data by the data transmission method in this invention is not fixed. That is, the output sequence of graphic, image, video, or audio data can be adjusted optionally. For example, the 1^{st} header and the 1^{st} graphic, image, video, or audio parameter can be delivered first, then transmit any number of graphic, image, video, or audio parameter, and transmit the 2^{nd} header and the subsidiary graphic, image, video, or audio parameter.

The objectives and other advantages of the invention will be realized and attained by the structure particularly pointed out in the written description and claims hereof as well as the appended drawings. In an attempt to have a further understanding of the data transmission method of this invention and the advantages superior than the conventional data transmission method for the portable communication apparatus, the unique features of the transmission method of the invention will be set forth in the description which follows, and in part will be apparent from the description, or may be learned by practice of the invention.

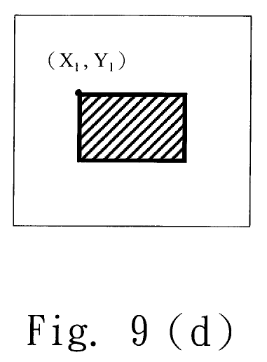

Please refer to FIG. 9, illustrated the steps for window opening on the display device of the portable communication apparatus. Generally, the following graphic, image, video, or audio steps are required for finishing the widow-opening operation (as illustrated in FIG. 9(a)) on the display of the portable communication apparatus, comprising of following steps: (1) storing the background (as illustrated in FIG. 9(b)), (2) filling the rectangle area (as illustrated in FIG. 9(c)), (3) drawing the four sides of the rectangle (as illustrated in FIG. 9(d)). According to the conventional data transmission method for the portable communication apparatus, the total transmitted bytes required for each graphic (for example) step is calculated as the followings:

<1> storing the background. X₁ (2 bytes), X coordinate of the 1^{st} standard address; Y₁ (2 bytes), Y coordinate of the 1^{st} standard address; Xlen (2 bytes), the length of the rectangle; Ylen (2 bytes), the width of the rectangle; the address (2 bytes) stored in the memory; and the graphic command (2 bytes) shall be transmitted, namely, 2+2+2+2+2+2=12 bytes of data shall be transmitted.

<2> filling the rectangle area: X₁ (2 bytes), X coordinate of the 1^{st} standard address; Y₁ (2 bytes), Y coordinate of the 1^{st} standard address; the length of the rectangle Xlen (2 bytes); Ylen (2 bytes), the width of the rectangle; the color C (2 bytes) for filling the rectangle; and the graphic command (2 bytes) shall be transmitted, namely, 2+2+2+2+2+2=12 bytes of data shall be transmitted.

<3> drawing the 1^{st} side of the rectangle: X₁ (2 bytes), X coordinate of the 1^{st} standard address; Y₁ (2 bytes), Y coordinate of the 1 st standard address; X₂ (2 bytes), X coordinate of the 2nd standard address; Y₂ (2 bytes), Y coordinate of the 2nd standard address; C (2 bytes), the color for filling the rectangle; and the graphic command (2 bytes) shall be transmitted, namely, 2+2+2+2+2+2=12 bytes of data shall be transmitted.

<4> drawing the 2^{nd} side of the rectangle: here, one end of the 1^{st} rectangle side concluded previously is taken as the 1^{st} standard address for carrying out the command of the continuous line drawing. Therefore, X₂ (2 bytes), X coordinate of the 2nd standard address; Y₂ (2 bytes), Y coordinate of the 2nd standard address; C (2 bytes), the color of the line, and the graphic command (2 bytes) shall be transmitted, namely, 2+2+2+2=8 bytes of data shall be transmitted.

<5> drawing the 3^{rd} side of the rectangle: at this process, one end of the 2nd rectangle side finished previously is taken as the 1^{st} standard address for carrying out the command of the continuous line-drawing. Therefore, X₂ (2 bytes), X coordinate of the 2nd standard address; Y₂ (2 bytes), Y coordinate of the 2nd standard address; C (2 bytes), the color of the line; and the graphic command (2 bytes) shall be transmitted, namely, 2+2+2+2=8 bytes of data shall be transmitted.

<6>drawing the 4^{th} side of the rectangle: at last in this process, one end of the 3rd rectangle side completed previously is taken as the 1^{st} standard address for carrying out the command of the continuous line-drawing.

Therefore, X₂ (2 bytes), X coordinate of the 2nd standard address; Y₂ (2 bytes), Y coordinate of the 2nd standard address; C (2 bytes), the color of the line; and the graphic command (2 bytes) shall be transmitted, namely, 2+2+2+2=8 bytes of data shall be transmitted.

Accordingly, the conventional data transmission method of the portable communication apparatus used for carrying out the opening-the-window process, totalizing 12+12+12+8+8+8=60 bytes of data shall be transmitted.

Comparing with this invention, related with the window-opening steps of the data transmission method for the portable communication apparatus, the total bytes required for each graphic (for example) step is calculated as the followings:

<1> storing the background: H₀+X₁ (2 bytes), H₁+X₂ (2 bytes), Xlen low byte+Ylen low byte (2 bytes, on the hypothesis that the length of the bytes of Xlen and Ylen is less than 256), and M_Addr (2 bytes) shall be transmitted, wherein the 1^{st} header Ho with the binary value of 0000011 is used for setting graphic command, and the 2^{nd} header H₁ is used for designating the combination of the graphic parameters data following after the graphic command. It includes the low bytes of the length and width of the rectangle window, (Xlenlowbyte+Ylenlowbyte), and the address (M_addr) are required to store in the display memory 231. From FIG. 5 and FIG. 8(b), it is found that the binary value of the 2^{nd} header H₁ is 0110110. Therefore, 2+2+2+2=8 bytes of data shall be transmitted.

<2> filling the rectangle area: H₀+Xlen (2 bytes) and H₁+Ylen (2 bytes) shall be transmitted, wherein the 1^{st} header H₀with the binary value of 1000000 is used for setting graphic command, and the 2^{nd} header H₁ is used for designating the combination of the graphic parameters data following after the graphic command. Among which, no graphic parameter is after the graphic command. From FIG. 5 and FIG. 8(b), it is found that the binary value of the 2^{nd} header H₁ is 1110000. Therefore, 2+2=4 bytes of data shall be transmitted.

<3> drawing the 1^{st} side of the rectangle: H₀+X₂ (2 bytes), H₁+Y₂ (2 bytes), and the line color C (2 bytes) shall be transmitted. As the parameter data of (X₁, Y₂), the X and Y coordinates of the 1^{st} standard address was already forwarded in the preceding transmission, no re-transmission of these parameters is needed in this transmission. The 1^{st} header H₀ with the binary value of 1000000 is used for setting graphic command. The 2^{nd} header H₁ is used for designating the combination of the graphic parameters data following after the graphic command. And C, the color of the line, is also included From FIG. 5 and FIG. 8(a), it is found that the binary value of the 2^{nd} header H₁ is 1110001. Therefore, 2+2+2=6 bytes of data shall be transmitted.

<4> drawing the 2^{nd} side of the rectangle: H₁+Y₂ (2 bytes) shall be transmitted. As the graphic command of continuous line-drawing was already forwarded in the preceding transmission, no re-transmission of graphic command, i.e., 1^{st} header H₀, but the transmission of graphic command parameters, i.e., the Y coordinate (Y₂) of the 2^{nd} standard address is needed in this transmission. The 2^{nd} header H₁ is used for designating the combination of the graphic parameters data following after the graphic command. No other graphic parameter is after the graphic command. From FIG. 5 and FIG. 8(a), it is found that the binary value of the 2^{nd} header H₁ should be 1110000. Therefore, totally 2 bytes of data shall be transmitted.

<5> drawing the 3^{rd} side of the rectangle: H₁+Y₂ (2 bytes) shall be transmitted. As the graphic command of continuous line-drawing was already forwarded in the last transmission, no re-transmission of graphic command, i.e., 1^{st} header H₀, but the transmission of graphic command parameters, i.e., the X coordinate (X₂) of the 2^{nd} standard address is needed in this transmission. The 2^{nd} header H₁ is used for designating the combination of the graphic parameters data following after the graphic command. No other graphic parameter is after the graphic command. From FIG. 5 and FIG. 8 (a), it is found that the binary value of the 2^{nd} header H₁ should be 1010000. Therefore, totally 2 bytes of data shall be transmitted.

<6> drawing the 4^{th} side of the rectangle: H₁+Y₂ (2 bytes) shall be transmitted. As the graphic command of continuous line-drawing was already forwarded in the last transmission, no re-transmission of graphic command, i.e., 1^{st} header Ho, but the transmission of graphic command parameters, i.e., the Y coordinate (Y₂) of the 2^{nd} standard address is needed in this transmission. The 2^{nd} header H₁ is used for designating the combination of the graphic parameters data following after the graphic command. No other graphic parameter is after the graphic command. From FIG. 5 and FIG. 8(a), it is found that the binary value of the 2^{nd} header H₁ should be 11110000. Therefore, totally 2 bytes of data shall be transmitted.

Accordingly, the conventional data transmission method of the portable communication apparatus used for carrying out the opening-the-window process, totalizing 8+4+6+2+2+2=24 bytes of data shall be transmitted.

From the aforesaid discussion, it is found that only 24 bytes shall be transmitted by the data transmission method of the portable communication apparatus in this invention, while 60 bytes shall be transmitted by the data transmission method of the conventionally portable communication apparatus. Therefore, in comparing the data transmission method in this invention, which is applicable to portable communication apparatus, and the data transmission method of the conventionally portable communication apparatus, the transmission efficiency could be enhanced by 60/24=2.5 times.

Especially, the floating headers in this invention are can be more than the above-mentioned two kinds of types. Any floating header with the form of the aforementioned two types could be used for achieving the object of this invention. At the same time, the structures of the said floating headers are not limited to the combination of the said three fields. Any structure with the combination of the above-mentioned three fields and any structure with the combination of, for example parameter ID field and command/indicator field of parameter data, are the variations of this invention, which will be under the protection of this invention.

Accordingly, the data transmission of this invention is to forward the graphic, image, video, or audio parameter with the subsidiary floating header preceding to the graphic, image, video, or audio parameter. The floating headers include at least two types. The 1^{st} header is for setting the graphic, image, video, or audio command. The 2^{nd} header is for designating the graphic, image, video, or audio parameter information following the graphic, image, video, or audio command, the combination of the said graphic, image, video, or audio command information, the transmission sequence of graphic, image, video, or audio parameter, and the combination data for the transmission of graphic, image, video, or audio parameters. In each graphic, image, video, or audio operation step, a 1^{st} header and a graphic, image, video, or audio parameter will be transmitted first. Then, a 2^{nd} header and a 2^{nd} graphic, image, video, or audio parameter will be transmitted. Next, the other graphic, image, video, or audio parameter will be transmitted as a completion. If the graphic, image, video, or audio command required in this graphic, image, video, or audio procedure is transmitted previously in the preceding data transmission step, then, the step for transmitting the setting of the graphic, image, video, or audio command of the 1^{st} header can be omitted. If the graphic, image, video, or audio parameters required in this graphic, image, video, or audio process are transmitted in the previous data transmission step, then, the said transmission step can be omitted. Moreover, after transmitting the 1^{st} and 2^{nd} headers and the graphic, image, video, or audio parameter of the said graphic, image, video, or audio command, an engine of the said portable communication apparatus will be started for completing the required graphic, image, video, or audio procedure of the graphic, image, video, or audio command. Most importantly, the transmission sequence for forwarding the graphic, image, video, or audio data by the data transmission method in this invention is not fixed. That is, the command of graphic, image, video, or audio data output can be adjusted optionally. Therefore, as the data transmission method of this invention can minimize the graphic, image, video, or audio parameter volume in each data transmission step, and for saving the power consumed by minimizing the transmitting amount of graphic, image, video, or audio parameters occur in each transmission step. Moreover, the total bytes of in data transmission could also be decreased, and the storage spaces for display memory 231 will also be relatively diminishes, namely, the cost will be lower as the hardware area is decreased. Furthermore, address bus can be used to transmitting graphic, image, video, or audio data, so that shortening the time for data transmission can enhance the data transmission efficiency.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A transmission data method for the portable communication apparatus includes plurality of data transmission steps and each data transmission step is used for completing a graphic, image, video, or audio process; wherein each step can be at least used for transmitting the 1^{st} header for setting a graphic, image, video, or audio command, the 2^{nd} header for designating the graphic, image, video, or audio parameter information following the graphic, image, video, or audio command and the combination of the said graphic, image, video, or audio command information, and transmitting the graphic, image, video, or audio parameter of the graphic, image, video, or audio command.

2. The data transmission method of claim 1, further includes: if the graphic, image, video, or audio command of this data transmission step has already been transmitted in the preceding data transmission step, then, the step for transmitting the 1^{st} header can be omitted.

3. The data transmission method of claim 1, further includes: if a graphic, image, video, or audio parameter of the graphic, image, video, or audio command in this data transmission step has already been transmitted in the preceding data transmission step, then, the step for transmitting the said graphic, image, video, or audio parameter can be omitted.

4. The data transmission method of claim 1, further includes: after transmitting the 1^{st} header, 2^{nd} header, and the graphic, image, video, or audio parameter of the said graphic, image, video, or audio command, a graphic, image, video, or audio engine of the said portable communication apparatus will be started to complete the graphic, image, video, or audio step demanded by the said graphic, image, video, or audio command.

5. The data transmission method of claim 1, wherein the 2^{nd} header further designates the transmission sequence of the graphic, image, video, or audio parameter of the said graphic, image, video, or audio command.

6. The data transmission method of claim 1, wherein the 2^{nd} header further designates to show how to merge transmitted information related to the graphic, image, video, or audio parameter of the graphic, image, video, or audio command

7. The data transmission method of claim 1, wherein the transmission sequence for the steps in forwarding the said 1^{st} header, 2^{nd} header, and the graphic, image, video, or audio parameter of the graphic, image, video, or audio command can be adjusted optionally.

8. The data transmission method of claim 1, wherein the plurality of data transmission steps are implemented on a parallel bus structure.

9. The data transmission method of claim 1, wherein the plurality of data transmission steps are implemented on a serial bus structure.

10. The data transmission method of claim 1, wherein the portable communication apparatus is a cellar phone.

11. The data transmission method of claim 1, wherein the portable communication apparatus is a PDA.

12. The data transmission method of claim 1, wherein the portable communication apparatus is wireless LAN equipment.

13. A floating header of the data transmission method for the portable communication apparatus, wherein the data transmission method includes plurality of transmission steps, and each data transmission step used for completing a graphic, image, video, or audio process, and the floating header at least includes:
a 1^{st} field for designating an attribute of a subsidiary graphic, image, video, or audio parameter following after a floating header; and
a 2^{nd} field for designating a graphic, image, video, or audio command of a required graphic, image, video, or audio process.

14. The floating header of claim 13, wherein the 1^{st} field is a data structure of 2 bytes, and 2^{nd} field is a data structure of 4 bytes.

15. The floating header of claim 13, wherein the 3^{rd} field with a binary value for setting the 2^{nd} field so as to designate the graphic, image, video, or audio command of a required graphic, image, video, or audio process.

16. The floating header of claim 15, wherein 3^{rd} field is a data structure of 1 byte.

17. The floating header of claim 15, wherein the 1^{st}, 2^{nd}, and 3^{rd} field is transmitted by an address bus, data bus or address/data bus of a parallel bus structure.

18. The floating header of claim 15, wherein the 1^{st}, 2^{nd}, and 3^{rd} field is transmitted by an address/data bus of a serial bus structure.

19. A floating header of the data transmission method for the portable communication apparatus, wherein the data transmission method includes plurality of transmission steps, and each data transmission step is used to carry out the graphic, image, video, or audio process, and the floating header at least includes:
a ^{1st} field for designating an attribute of a subsidiary graphic, image, video, or audio parameter following after the floating header; and
a 2^{nd} field for designating the graphic, image, video, or audio parameter information following a graphic, image, video, or audio command and the combination of the said graphic, image, video, or audio command information.

20. The floating header of claim 19, wherein the 1^{st} field is a data structure of 2 bytes, and said 2^{nd} field is a data structure of 4 bytes.

21. The floating header of claim 19, wherein the 2^{nd} field further designates a transmission sequence of the graphic, image, video, or audio parameters of graphic, image, video, or audio command.

22. The floating header of claim 19, wherein the 2^{nd} field further designates to show how to merge transmitted information related to the graphic, image, video, or audio parameter of the graphic, image, video, or audio command.

23. The floating header of claim 19, wherein the 2^{nd} field further designates the sequence of the parameters of the graphic, image, video, or audio command.

24. The floating header of claim 19, further includes: a 3^{rd} field with a binary value for setting the 2^{nd} field so as to designate the graphic, image, video, or audio parameter information of a graphic, image, video, or audio command, and a combination of the graphic, image, video, or audio command information.

25. The floating header of claim 24, wherein the 3rd field is a data structure of 1 byte.

26. The floating header of claim 24, wherein the 1^{st}, 2^{nd}, and 3rd field is transmitted by an address bus, data bus or address/data bus of a parallel bus structure.

27. The floating header of claim 24, wherein the 1^{st}, 2^{nd}, and 3^{rd} field is transmitted by an address/data bus of a serial bus structure.
